(19) United States
(12) Patent Application Publication
(10) Pub. No.: US 2008/0288436 A1
(43) Pub. Date: Nov. 20, 2008

(54) DATA PATTERN MATCHING TO REDUCE NUMBER OF WRITE OPERATIONS TO IMPROVE FLASH LIFE

(76) Inventor: HARSHA PRIYA N V, Bangalore (IN)

Correspondence Address: INTEL CORPORATION;c/o INTELLEVATE, LLC, P.O. BOX 52050, MINNEAPOLIS, MN, 55402, US

(21) Appl. No.: 11/749,086

(22) Filed: May 15, 2007

(51) Int. Cl. G06N 5/02

(52) U.S. Cl. 706/48

(57) ABSTRACT

A processing engine examines data to determine whether the received data is a sector filled with zero value data that may be mapped to a physical storage location already filled with zero value data. If the management software does not find the received data to be just zeros, the data is compared with stored patterns that are mapped to compressed encodings that correspond to the received data. The management software learns new data patterns and creates compressed encodings for future use. In a read mode the management software reverses the process to provide data stored in the memory device.

Technological developments permit digitization and compression of large amounts of voice, video, imaging, and data information, which may be transmitted from laptops and other digital equipment to other devices within the network. These developments in digital technology and enhancements to applications have stimulated a need for memory storage to handle the higher data volume supplied to these processing devices. Therefore, improved circuits and improved methods are needed to increase the efficiency of memory operations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device that may store data and executable code in a non-volatile memory that includes data pattern recognition in accordance with the present invention;

FIG. 2 is a flow diagram that depicts the initialization of the non-volatile memory to facilitate the data pattern recognition algorithm in accordance with the present invention; and

FIG. 3 is a flow diagram that depicts an algorithm and the memory management processes for use with a non-volatile memory.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Developments in a number of different digital technologies have greatly increased the need to store and transfer data from one device across a network to another system. Technological developments permit digitization and compression of large amounts of voice, video, imaging, and data information, which may be transmitted from laptops and other digital equipment to other devices within the network. The present invention may facilitate applications using higher resolution displays, better image capturing cameras, more storage capability, and new applications for mobile video. As such, the present invention may be used in a variety of products with the claimed subject matter incorporated into desktop computers, laptops, smart phones, MP3 players, USB drives, memory cards, cameras, communicators and Personal Digital Assistants (PDAs), medical or biotech equipment, automotive safety and protective equipment, automotive infotainment products, etc. However, it should be understood that the scope of the present invention is not limited to these examples.

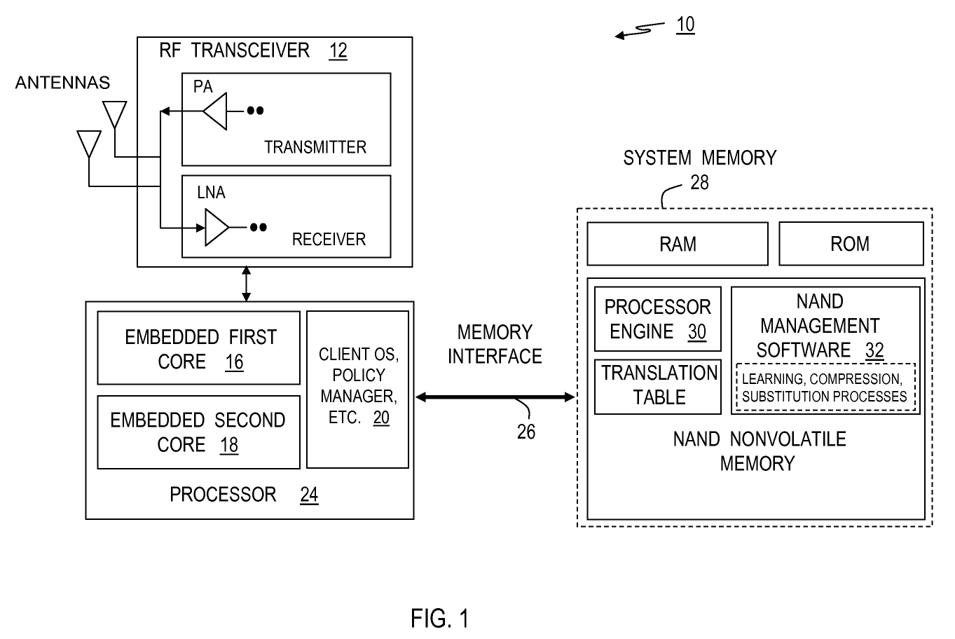

FIG. 1 is a diagram that illustrates an embodiment that couples antenna(s) to a transceiver 12 to accommodate modulation/demodulation. Analog transceiver 12 is coupled with a processor 24 to process functions that fetch instructions, generate decodes, find operands, and perform appropriate actions, then stores results. The processor may include baseband and applications processing functions and utilize one or more processor cores 16 and 18 to handle application functions and allow processing workloads to be shared across the cores. The processor may transfer data through an interface 26 to memory storage in a system memory 28. The figure further illustrates in accordance with embodiments of the present invention, a client operating system (OS) and a policy manager resident in processor 24 that operate in conjunction with an engine 30 and memory management software 32 within the Non-Volatile Memory (NVM).

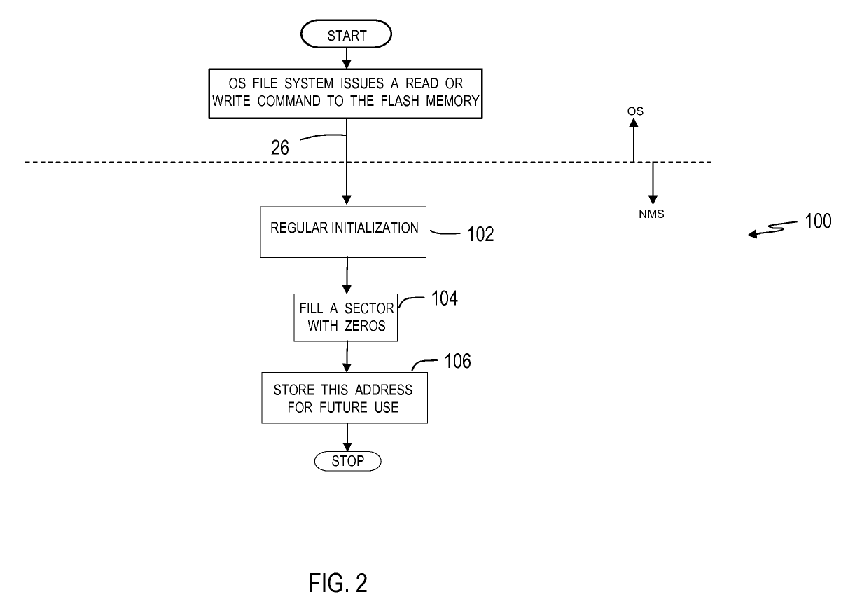

FIG. 2 is a flow diagram that illustrates a sequence of initialization steps that may be performed along with the regular NAND memory initialization steps. In detail, the figure depicts the functions and processes to fix a pre-defined physical memory chunk in terms of physical memory address and fill the block with zeros. Method 100 may be executed by processor engine 30 using NAND management software 32 to initialize the nonvolatile NAND memory. Method 100 is shown beginning at block 102 where commands from host processor 24 are received via interface 26 for nonvolatile NAND memory initialization. In block 102, NAND management software 32 makes the regular initializations for the memory, and then in block 104 fixes a pre-determined physical memory chunk and fills it with zeros. Finally, the initialization process ends with the block 106 where this physical memory address is stored for future memory mappings in accordance with the present invention.

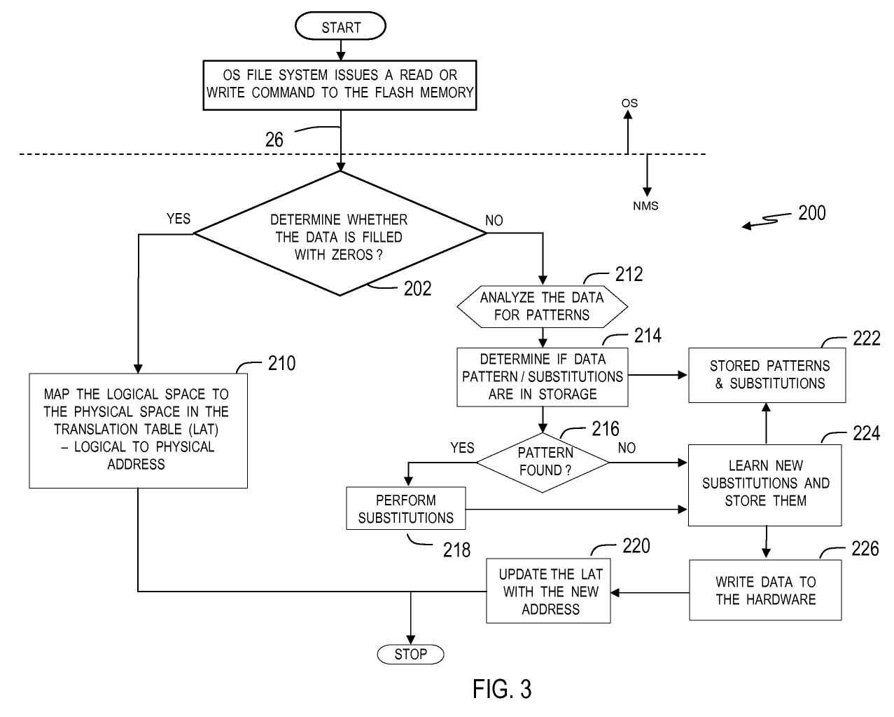

FIG. 3 is a flow diagram that illustrates an algorithm directed towards the memory management processes that may be used with a non-volatile memory. In particular, the figure depicts a control flow managed by the NAND Management Software for the nonvolatile NAND flash memory in accordance with the present invention. The control flow describes functionalities and processes to analyze data transferred by the intermediate policy manager or by the file system under control of the operating system 20 to the port driver of the host processor 24 to be written to the NAND memory.

Method 200 may be executed by engine 30 using NAND management software 32 in accordance with the present invention to support pattern matching, data compressing and internal address mapping, among other functions. It is well known that memory write operations are destructive operations in flash devices and have a limitation of data being overridden in memory locations. Therefore, it is prudent to reduce the number of write commands issued to the flash device. By incorporating the present algorithm, method 200 reduces or minimizes the number of write operations to the NAND memory, and thereby increases the life time of the NAND device. The designated set of executable processes defined in method 200 is managed within the non-volatile memory to allow the host processor, i.e., processor 24, to disassociate from managing additional processes linked with the non-volatile memory write operations.

In some embodiments, method 200, or portions thereof, is performed by engine 30 operating as a controller, a processor, or an electronic system. Method 200 is not limited by the particular type of apparatus, software element, or system performing the method. Note that the various actions in method 200 may be performed in the order presented, or may be performed in a different order, where some actions listed in FIG. 3 may be omitted from embodiments using method 200. Note that a non-volatile memory may be divided into logical blocks referred to as Erase blocks, VPages and sectors. Once data is written to a VPage, the entire Erase block needs to be erased before modified data is written to this same VPage, a constraint that is a time consuming sequence of operations and also reduces the life of the non-volatile memory.

Method 200 is shown beginning at block 202 where data from processor 24 is received via interface 26 for storage by the non-volatile memory. NAND management software 32 in block 202 makes a determination about the content of the data received from processor 24. Engine 30 includes hardware to determine whether the data received from processor 24 is a VPage/sector filled with zeros. By way of example, the operating system during format operations may transfer fields of zeros to be written to the physical disk. Upon detecting that the data includes a VPage/sector filled with zeros, block 210 illustrates a mapping of the internal logical-to-physical translation in a translation table such that all the VPage/sectors that need to have zeros written are internally mapped to the same zero filled VPage/sector described in block 106 (see FIG. 2). The hardware and algorithm allow, for example, byte wise comparisons or simple addition operations where at any time during the operation a non-zero result indicates that the VPage/sector is not filled with a data field of zeros.

Returning to block 202, if it is determined that a VPage/sector is not filled with zeros then the received data is analyzed to determine data patterns, see block 212. In a regular write sequence, the data to be written may have previously identified data patterns that may be stored in compressed encodings. It should be noted that such data encodings occupy comparatively less memory space than the actual data. The data patterns identified in block 214 are compared with previously found and stored patterns in block 222. Block 222 may be populated for data patterns with its encoded substitutions at the initialization stage of NAND management software itself. The data patterns with its substitutions populated shall differ based on usage scenarios. By way of example, if it is an extensive text-based data storage system then words like ‘the’, ‘which’, ‘with’, ‘are’, ‘is’, ‘and’, etc., may be pre-populated with substitutions that take the least amount of memory space. These pre-determined data patterns and compressed encodings may be based on heuristics.

If the received data pattern matches a previously stored data pattern as determined in block 216, an optimal substitution is performed in block 218 on matching data patterns. However, if the data pattern was not found then block 224 shows that the algorithm provides a learning and executing phase to learn new substitutions that may be stored in block 222 for future use. Thus, data sent by processor 24 to be written and stored in the non-volatile memory is analyzed and compression substitutions are prepared.

In operation, processor 24 may write data via interface 26 for storage by the non-volatile memory, where data having a value of ‘0000’ as analyzed and compressed by NAND management software 32 may be replaced by a data value of #0, for example. Any further data corresponding to the actual # that is sent by operating system of processor 24 for storage is matched to the previously stored pattern and the substitution value provides a prefixed value of #.

Thus, the algorithm for the present invention has a learning process, a compression process, and a substitution process used to analyze the data for existing data patterns and provide substitution patterns to avoid writing repetitive data to the non-volatile memory. The substitution patterns are reversed when the data is read and passed back to the operating system of processor 24.

By now it should be apparent that embodiments of the present invention allow designs of single bit per cell (SBC) or multiple bits per cell in a multi-level cell (MLC) Flash technology to include circuitry and an algorithm in the NMS that ensures that repetitive data patterns written to the memory cause a minimal number of write operations. By logically mapping the same data patterns to a same physical storage location and compressing the data, minimal data write operations to the flash may extend the lifetime of the memory device. Further, the present algorithm may ensure that disk formatting and deletions of file data do not cause physical writes to the flash. Without this algorithm there is a high possibility that similar kinds of data may be written at multiple memory locations, thereby increasing the number of write operations to the non-volatile memory.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A non-volatile memory to execute a data management process, comprising:
a processing engine to receive data at terminals of the non-volatile memory that is analyzed to determine whether the received data fills a sector with zero value data that is mapped to a physical storage location already filled with zero value data.

2. The non-volatile memory of claim 1 wherein a translation table accessible to the processing engine maps same data patterns to a same physical storage location.

3. The non-volatile memory of claim 1 wherein the processing engine includes comparison circuitry to determine if the received data is a pattern that matches one of previously stored patterns.

4. The non-volatile memory of claim 1 wherein the non-volatile memory includes a compression block to provide a substitution pattern for repetitive data patterns written to the memory.

5. A memory device having a translation table, comprising:
a processing engine to perform data pattern recognition to match received data with stored patterns and use the translation table to map a recognized pattern to a substitute compressed encoding.

6. The memory device of claim 5 wherein the translation table maps same data patterns to a same physical storage location.

7. The memory device of claim 5 wherein the processing engine analyzes received data to determine a zero filled sector and use the translation table to map to a physical space previously stored as a zero filled sector.

8. The memory device of claim 5 wherein the processing engine analyzes the received data to learn and store new patterns for use as substitutions by the translation table.

9. The memory device of claim 5 wherein the processing engine performs data pattern recognition for a single bit per cell (SBC).

10. The memory device of claim 5 wherein the processing engine performs data pattern recognition for a multi-level cell (MLC) Flash technology.

11. A wireless system to include system memory, comprising:
a transceiver to modulate and demodulate a signal;
a processor having first and second cores coupled to the transceiver; and
a nonvolatile memory coupled to the processor and having an engine to analyze received data to recognize patterns matched to previously received patterns that map to substitute patterns.

12. The wireless system of claim 11 wherein the substitute patterns are compressed patterns.

13. The wireless system of claim 12 wherein the engine learns new substitute patterns that are stored for use as previously received patterns.

14. The wireless system of claim 11 wherein the nonvolatile memory includes a translation table to map received patterns to substitute patterns.

15. A method comprising:
analyzing data received in a non-volatile memory;
compressing the data; and
mapping same data patterns to a same physical storage location.

16. The method of claim 15, wherein mapping same data patterns to a same physical storage location ensures that disk formatting does not cause physical writes to the flash.

17. The method of claim 15, wherein mapping same data patterns to a same physical storage location ensures that file deletions do not cause physical writes to the flash.

18. The method of claim 15, wherein mapping same data patterns to a same physical storage location ensures minimal data write operations to the non-volatile memory.

19. The method of claim 15, further comprising learning new substitution patterns based on analyzing data received in a non-volatile memory.

20. The method of claim 19, wherein learning new substitution patterns is used to update a translation table to expand mapping same data patterns to a same physical storage location.
